(19) United States
(12) Patent Application Publication
(10) Pub. No.: US 2019/0348047 A1
(43) Pub. Date: Nov. 14, 2019

(54) INTEGRATED SPEECH RECOGNITION SYSTEMS AND METHODS

(71) Applicant: Quanta Computer Inc., Taoyuan City (TW)

(72) Inventors: Tu-Jung LI, Taoyuan City (TW); Chen-Chung LEE, Taoyuan City (TW); Chun-Hung CHEN, Taoyuan City (TW); Chien-Kuo HUNG, Taoyuan City (TW)

(21) Appl. No.: 16/217,101

(22) Filed: Dec. 12, 2018

(30) Foreign Application Priority Data
May 9, 2018 (TW) 107115723

(51) Int. Cl. G10L 15/32; G10L 15/22; G10L 15/30

(52) U.S. Cl. CPC G10L 15/32; G10L 15/30; G10L 15/22

(57) ABSTRACT

An integrated speech recognition system including a storage device and a controller is provided. The storage device stores a plurality of first scores corresponding to a plurality of users for each of a plurality of speech recognition services. The controller selects a first user group from a plurality of user groups according to user data, obtains a plurality of recognition results which are generated by the speech recognition services for the same speech data, and generates a recommendation list by sorting the recognition results according to the first scores corresponding to the users in the first user group.

### CROSS REFERENCE TO RELATED APPLICATIONS

This Application claims priority of Taiwan Application No. 107115723, filed on May 9, 2018, the entirety of which is incorporated by reference herein.

### BACKGROUND OF THE APPLICATION

### Field of the Application

The application relates generally to speech recognition technologies, and more particularly, to integrated speech recognition systems and methods which integrate multiple speech recognition services.

### Description of the Related Art

With the widespread use of digital devices, various forms of user interfaces have been developed to allow users to operate such devices. For example, flat panel displays with a capacitive touch interface have been widely used as representative user interfaces because they are more intuitive than traditional user interfaces consisting of a keyboard and/or a mouse. However, a touch interface may not be easy to use under certain circumstances. For example, it can be difficult to use a touch interface when both of the user's hands are occupied (e.g., when the user is driving a vehicle), when a complicated command needs to be executed, or when a long text needs to be input.

Alternatively, the speech interface may be intuitive, as well as compensating for flaws found in the touch interface. Thus, the use of the speech interface is desirable in a wider range of applications, such as, for example, controlling devices while driving a vehicle, or using voice assistance for executing a complicated command. In general, a speech interface relies on speech recognition to transform the speech data into text or machine code/instructions. However, known speech recognition services suffer from inaccuracies due to the differences between languages and even between accents of the same language.

There are many speech recognition services available in the market, and each of them may use a different speech recognition technology. As a result, these speech recognition services may generate different recognition results for the same speech data (e.g., the same phrase of the same language) due to the particular accent of the speaker.

### BRIEF SUMMARY OF THE APPLICATION

In order to solve the aforementioned problems, the present application proposes integrated speech recognition systems and methods in which users are categorized into groups and the scores of multiple speech recognition services are analyzed according to the user groups to recommend a speech recognition service that may provide better accuracy for a particular user.

In one aspect of the application, an integrated speech recognition system comprising a storage device and a controller is provided. The storage device is configured to store a plurality of first scores corresponding to a plurality of users for each of a plurality of speech recognition services. The controller is configured to select a first user group from a plurality of user groups according to user data, obtain a plurality of recognition results which are generated by the speech recognition services for the same speech data, and generate a recommendation list by sorting the recognition results according to the first scores corresponding to the users in the first user group.

In another aspect of the application, an integrated speech recognition method, executed by a server comprising a storage device storing a plurality of first scores corresponding to a plurality of users for each of a plurality of speech recognition services, is provided. The integrated speech recognition method comprises the steps of: selecting a first user group from a plurality of user groups according to user data; obtaining a plurality of recognition results which are generated by the speech recognition services for the same speech data; and generating a recommendation list by sorting the recognition results according to the first scores corresponding to the users in the first user group.

Other aspects and features of the application will become apparent to those with ordinary skill in the art upon review of the following descriptions of specific embodiments of the integrated speech recognition systems and methods.

### BRIEF DESCRIPTION OF THE DRAWINGS

The application can be more fully understood by reading the subsequent detailed description and examples with references made to the accompanying drawings, wherein:

FIG. 1 is a block diagram illustrating a communication network environment according to an embodiment of the application;

FIG. 2 is a block diagram illustrating the hardware architecture of the integrated speech recognition system 170 according to an embodiment of the application;

FIG. 3 is a flow chart illustrating the integrated speech recognition method according to an embodiment of the application; and

FIGS. 4A-4E show a schematic diagram illustrating a software implementation view of providing the integrated speech recognition service according to an embodiment of the application.

### DETAILED DESCRIPTION OF THE APPLICATION

The following description is made for the purpose of illustrating the general principles of the application and should not be taken in a limiting sense. It should be understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

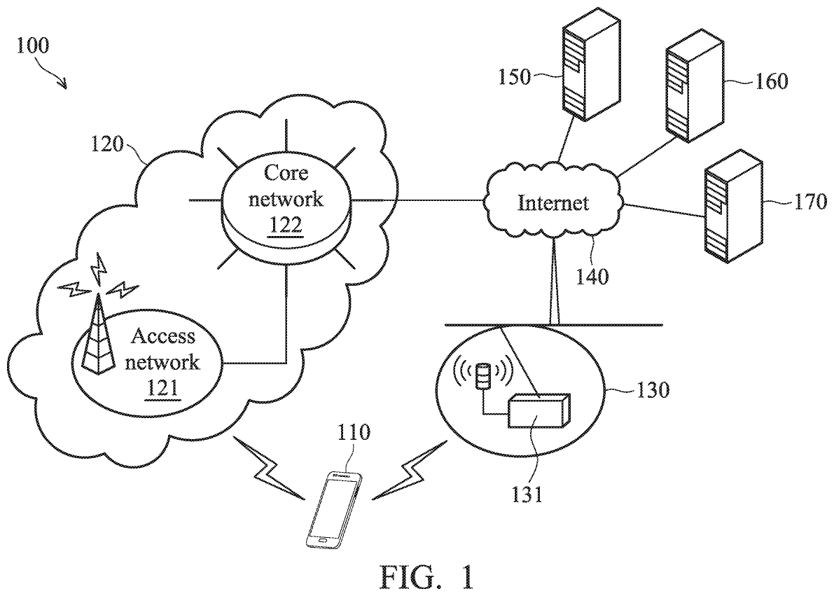

FIG. 1 is a block diagram illustrating a communication network environment according to an embodiment of the application. The communication network environment 100 includes a user device 110, a telecommunication network 120, a Wireless Local Area Network (WLAN) 130, the Internet 140, speech recognition servers 150˜160, and an integrated speech recognition system 170.

The user device 110 may be a smart phone, a panel Personal Computer (PC), a laptop computer, or any computing device supporting at least one of the telecommunication technology utilized by the telecommunication network 120 and the wireless technology utilized by the WLAN 130. Specifically, the user device 110 may selectively connect to the telecommunication network 120 or the WLAN 130 to obtain wireless access to the Internet 140, and further connect to the integrated speech recognition system 170 via the Internet 140.

The telecommunication technology utilized by the telecommunication network 120 may be the Global System for Mobile communications (GSM) technology, the General Packet Radio Service (GPRS) technology, the Enhanced Data rates for Global Evolution (EDGE) technology, the Wideband Code Division Multiple Access (WCDMA) technology, the Code Division Multiple Access 2000 (CDMA-2000) technology, the Time Division-Synchronous Code Division Multiple Access (TD-SCDMA) technology, the Worldwide Interoperability for Microwave Access (WiMAX) technology, the Long Term Evolution (LTE) technology, the Time-Division LTE (TD-LTE) technology, or the LTE-Advanced (LTE-A) technology, etc.

Specifically, the telecommunication network 120 includes an access network 121 and a core network 122, wherein the access network 121 is responsible for processing radio signals, terminating radio protocols, and connecting the user device 110 with the core network 122, while the core network 122 is responsible for performing mobility management, network-side authentication, and interfaces with public/external networks (e.g., the Internet 140).

The WLAN 130 may be established by an AP 131 utilizing the Wireless-Fidelity (Wi-Fi) technology, implemented as an alternative for providing wireless services for the user device 110. Specifically, the AP 131 may connect to a wired local area network by an Ethernet cable, and further connect to the Internet 140 via the wired local area network. The AP 131 typically receives, buffers, and transmits data between the WLAN 130 and the user device 110. It should be understood that the AP 131 may utilize another wireless technology, such as the Bluetooth technology or the Zigbee technology, and the present application should not be limited thereto.

Each of the speech recognition servers 150 and 160 may be a cloud server which is responsible for using a speech recognition engine to provide a speech recognition service to the connected devices (e.g., the user device 110 and the integrated speech recognition system 170) on the Internet 140. The speech recognition service may be any one of the following: the Google Cloud Speech service, the Microsoft Azure Bing Speech service, the Amazon Alexa Voice Service, and the IBM Bluemix Watson service. For example, the speech recognition server 150 may provide the Google Cloud Speech service, while the speech recognition server 160 may provide the Microsoft Azure Bing Speech service.

It should be understood that the communication network environment may include additional speech recognition servers, such as a speech recognition server for providing the Amazon Alexa Voice Service, and a speech recognition server for providing the IBM Bluemix Watson service.

The integrated speech recognition system 170 may be a (cloud) server which is responsible for providing an integrated speech recognition service. The user device 110 may send speech data to the integrated speech recognition system 170 where the recognition results from different speech recognition servers are integrated. Specifically, the integrated speech recognition system 170 may analyze the scores corresponding to multiple users for each speech recognition service according to the result of user grouping, so as to determine a speech recognition service that is most suitable to the user device 110. In addition, the integrated speech recognition system 170 may further compare the recognition results to the user's selection feedback, and adjust the weighting ratio according to the comparison results.

In one embodiment, the integrated speech recognition system 170 may use the Application Programming Interfaces (APIs) published by the speech recognition service providers to access the speech recognition services provided by the speech recognition servers 150 and 160 and to obtain the recognition results.

It should be understood that the components described in the embodiment of FIG. 1 are for illustrative purposes only and are not intended to limit the scope of the application. For example, the speech recognition servers 150 and 160 may be incorporated into the integrated speech recognition system 170. That is, the integrated speech recognition system 170 may have built-in speech recognition engines to provide the speech recognition services. Alternatively, the integrated speech recognition system 170 may receive the speech data from an internal or external storage device, instead of the user device 110.

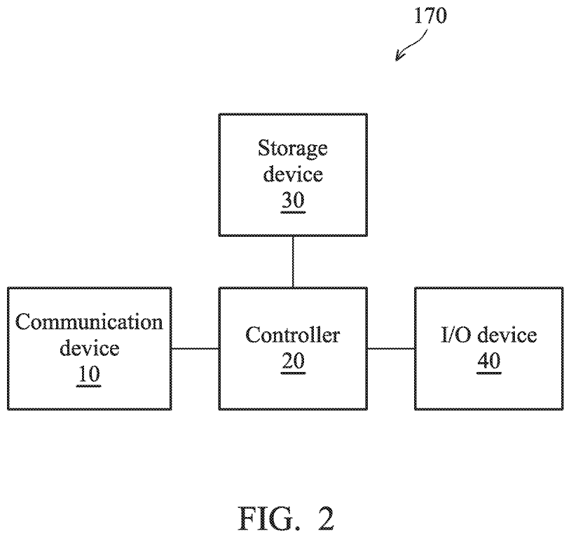

FIG. 2 is a block diagram illustrating the hardware architecture of the integrated speech recognition system 170 according to an embodiment of the application. The integrated speech recognition system 170 includes a communication device 10, a controller 20, a storage device 30, and an Input/Output (I/O) device 40.

The communication device 10 is responsible for providing a connection to the Internet 140, and then to the user device 110 and the speech recognition servers 150 and 160 through the Internet 140. The communication device 10 may provide a wired connection using Ethernet, optical network, or Asymmetric Digital Subscriber Line (ADSL), etc. Alternatively, the communication device 10 may provide a wireless connection using the Wi-Fi technology or any telecommunication technology.

The controller 20 may be a general-purpose processor, Micro-Control Unit (MCU), Application Processor (AP), Digital Signal Processor (DSP), or any combination thereof, which includes various circuits for providing the function of data processing/computing, controlling the communication device 10 for connection provision, storing and retrieving data to and from the storage device 30, and outputting feedback signals or receiving configurations from the manager of the integrated speech recognition system 170 via the I/O device 40. In particular, the controller 20 may coordinate the communication device 10, the storage device 30, and the I/O device 40 for performing the integrated speech recognition method of the present application.

As will be appreciated by persons skilled in the art, the circuits in the controller 20 will typically comprise transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory computer-readable storage medium, including a memory, such as a FLASH memory or a Random Access Memory (RAM), or a magnetic storage device, such as a hard disk or a magnetic tape, or an optical disc, or any combination thereof for storing instructions or program code of communication protocols, applications, and/or the integrated speech recognition method. In particular, the storage device 30 may further maintain a database for storing the scores corresponding to a plurality of users for each speech recognition service, the recommendation accuracy coefficient for each recommendation, and the rule(s) for user grouping.

The I/O device 40 may include one or more buttons, a keyboard, a mouse, a touch pad, a video camera, a microphone, a speaker, and/or a display device (e.g., a Liquid-Crystal Display (LCD), Light-Emitting Diode (LED) display, or Electronic Paper Display (EPD)), etc., serving as the Man-Machine Interface (MMI) for receiving configurations (e.g., the rule(s) for user grouping, the weighting ratio, the management (adding/deleting) of speech recognition services) from the manager of the integrated speech recognition system 170, and outputting feedback signals.

It should be understood that the components described in the embodiment of FIG. 2 are for illustrative purposes only and are not intended to limit the scope of the application. For example, the integrated speech recognition system 170 may include additional components, such as a power supply, and/or a Global Positioning System (GPS) device.

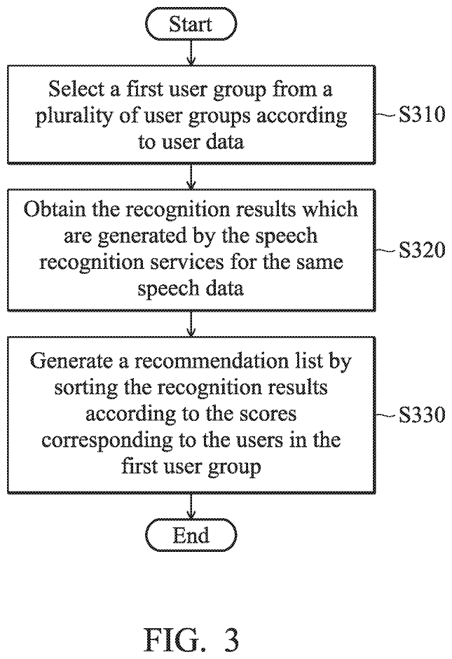

FIG. 3 is a flow chart illustrating the integrated speech recognition method according to an embodiment of the application. In this embodiment, the integrated speech recognition method may be applied to a cloud server, such as the integrated speech recognition system 170.

To begin with, the integrated speech recognition system selects a first user group from a plurality of user groups according to user data (step S310). The first user group represents the group to which the current user belongs (after user grouping).

In one embodiment, the integrated speech recognition system may receive the user data from a connected device (e.g., the user device 110) on the Internet 140, or from an internal or external storage device of the integrated speech recognition system. The user data may include at least one of the following: the Internet Protocol (IP) address, location information, gender information, and age information. The location information may be generated by the built-in GPS device of the user device 110, or may be the residence information manually input by the user.

In one embodiment, the user grouping may be performed according to the locations of the users, due to the consideration that the users from different geographic areas may have different accents or different oral expression styles. For example, the IP addresses and/or the location information of the users may be used to determine the users' locations, such as Taipei, Taichung, Kaohsiung, Shanghai, or Beijing, etc.

Next, the integrated speech recognition system obtains the recognition results which are generated by the speech recognition services for the same speech data (step S320). In one embodiment, the integrated speech recognition system may receive the speech data from a connected device (e.g., the user device 110) on the Internet 140, or from an internal or external storage device of the integrated speech recognition system.

In one embodiment, the integrated speech recognition system (e.g., the integrated speech recognition system 170) may connect to different speech recognition servers (e.g., the speech recognition servers 150˜160) via the Internet (e.g., the Internet 140) to access different speech recognition services. In another embodiment, the integrated speech recognition system may be configured with built-in speech recognition engines to provide the speech recognition services.

After that, the integrated speech recognition system generates a recommendation list by sorting the recognition results according to the scores corresponding to the users in the first user group (step S330), and the method ends.

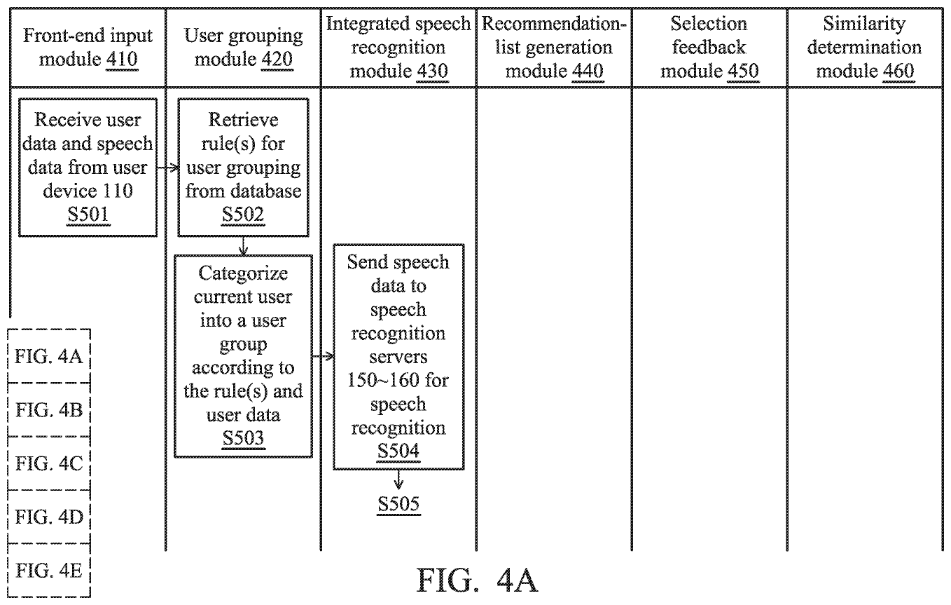

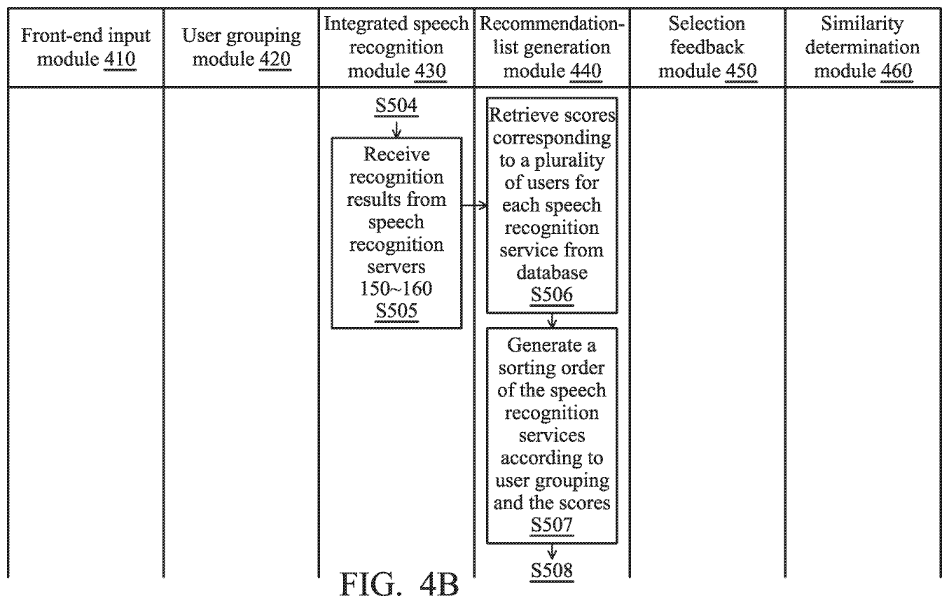

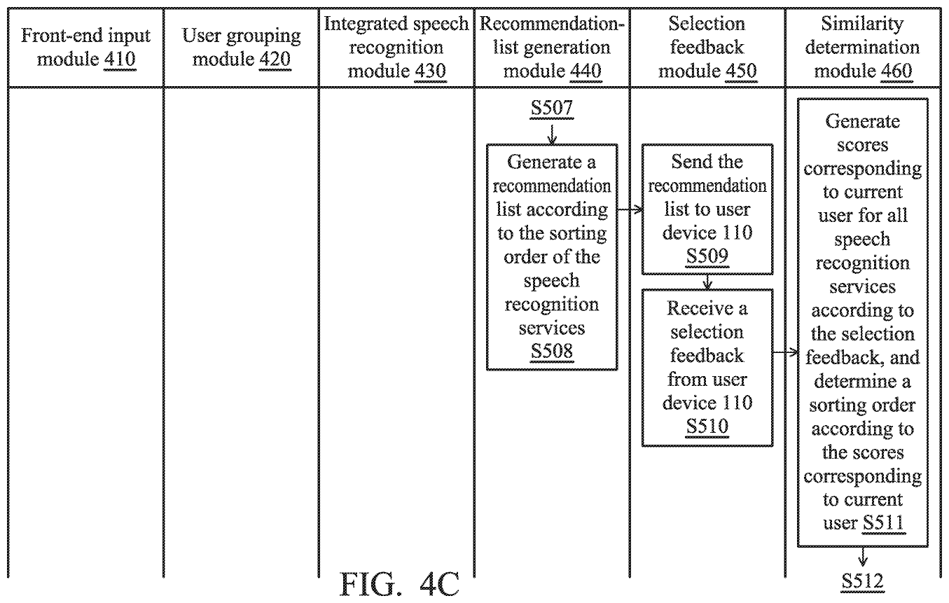

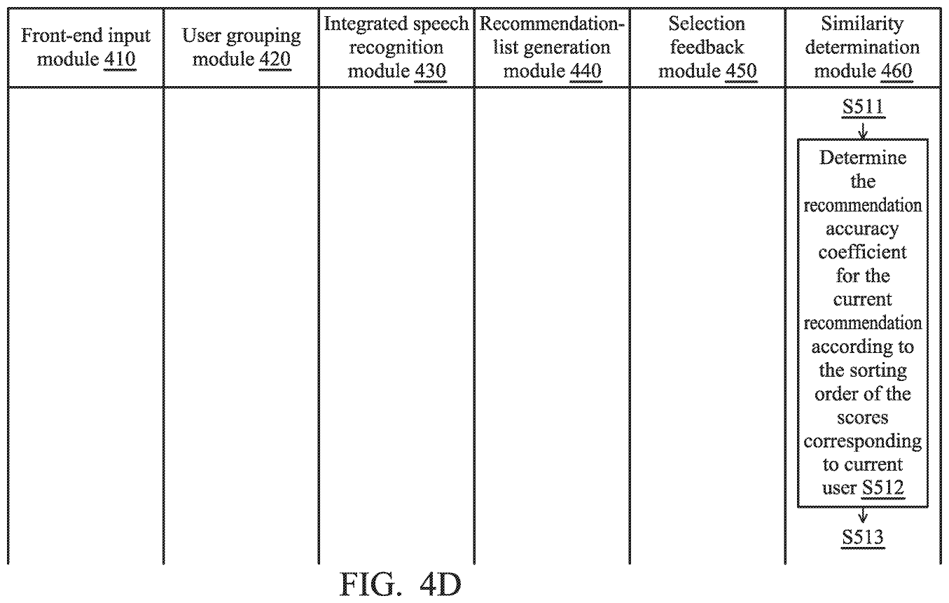

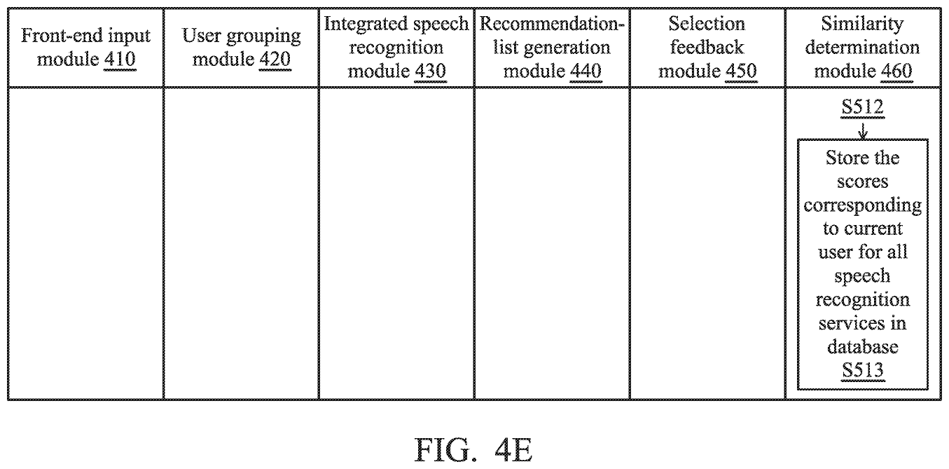

The details of each step of the integrated speech recognition method in FIG. 3 will be described later in FIGS. 4A-4E.

FIGS. 4A-4E show a schematic diagram illustrating a software implementation view of providing the integrated speech recognition service according to an embodiment of the application. In this embodiment, the software architecture of the integrated speech recognition method includes a front-end input module 410, a user grouping module 420, an integrated speech recognition module 430, a recommendation-list generation module 440, a selection feedback module 450, and a similarity determination module 460. The software modules may be realized in program code which, when executed by a processor or controller of a cloud server (e.g., the controller 20 of the integrated speech recognition system 170), enables the processor/controller to perform the integrated speech recognition method.

Firstly, the front-end input module 410 is responsible for providing an interface for the communications between the user device 110 and the integrated speech recognition system 170.

Through the interface, the integrated speech recognition system 170 may receive the user data and speech data of the current user (e.g., user F) from the user device 110 (step S501). In another embodiment, the front-end input module 410 may further receive device data (e.g., device model, and/or Operating System (OS) version, etc.) of the user device 110 from the user device 110.

Secondly, the user grouping module 420 is responsible for retrieving the rule(s) for user grouping from the database (step S502), and categorizing the current user (e.g., user F) into a user group according to the rule(s) and the user data (step S503).

For example, the rule(s) for user grouping may indicate that the user grouping is performed based on the users' locations. That is, the IP addresses and/or the location information (e.g., GPS information) in the user data may be used to determine the users' locations for user grouping.

Thirdly, the integrated speech recognition module 430 is responsible for providing an interface for the communications between the speech recognition servers 150˜160 and the integrated speech recognition system 170.

Through the interface, the integrated speech recognition system 170 may send the speech data to the speech recognition servers 150˜160 for speech recognition (step S504), and receive recognition results from the speech recognition servers 150˜160 (step S505). The interface may be implemented using the APIs provided by the providers of the speech recognition services of the speech recognition servers 150˜160.

Fourthly, the recommendation-list generation module 440 is responsible for retrieving the scores corresponding to a plurality of users (e.g. previous users A˜E) for each speech recognition service from the database (step S506). Also, the recommendation-list generation module 440 is responsible for generating a sorting order of the speech recognition services according to the user grouping and the scores (step S507), and generating a recommendation list according to the sorting order of the speech recognition services (step S508).

Specifically, the database is responsible for storing the user grouping of a plurality of users (e.g. previous users A˜E) from the previous recommendations, the scores Rᵢ corresponding to the users for each speech recognition service (i represents the index of a speech recognition service), and the recommendation accuracy coefficients for the previous recommendations corresponding to the users. An example of the database is shown in Table 1 as follows.

TABLE 1

| User | Grouping | R1 | R2 | R3 | R4 | β |
|---|---|---|---|---|---|---|
| User A | Taipei | 0.9 | 0.85 | 0.84 | 0.85 | 1 |
| User B | Taipei | 0.88 | 0.8 | 0.86 | 0.84 | 1 |
| User C | Taichung | 0.82 | 0.82 | 0.92 | 0.83 | 0 |
| User D | Kaosiung | 0.83 | 0.85 | 0.88 | 0.95 | 0 |
| User E | Shanghai | 0.86 | 0.85 | 0.93 | 0.83 | 1 |

In the exemplary database shown in Table 1, the user grouping is performed based on the users' locations. The higher value of the score Rᵢ indicates a higher accuracy of the corresponding speech recognition service. The recommendation accuracy coefficient indicates whether the recommendation list matches the user's selection. If the recommendation list matches the user's selection, the value of the recommendation accuracy coefficient is set to 1. Otherwise, if the recommendation list does not match the user's selection, the value of the recommendation accuracy coefficient is set to 0. The details regarding the calculations of the score Rᵢ and the recommendation accuracy coefficient β will be described later.

The step S507 may include three sub-steps. The first sub-step of step S507 is to calculate a first average score ARᵢ for each speech recognition service according to the scores corresponding to all previous users (i.e., users A˜E). According to the database shown in Table 1, the first average scores of all speech recognition services and the sorting order of the first average scores may be determined as follows in Table 2.

TABLE 2

| Index (i) | | |
|---|---|---|
| of speech | | Sorting order |
| recognition | | of ARᵢ (first |
| service | ARᵢ | sorting order) |
| 1 | $\frac{0.9 + 0.88 + 0.82 + 0.83 + 0.86}{5} = 0.858$ | 3 |
| 2 | $\frac{0.85 + 0.8 + 0.82 + 0.85 + 0.85}{5} = 0.834$ | 4 |
| 3 | $\frac{0.84 + 0.86 + 0.92 + 0.88 + 0.93}{5} = 0.886$ | 1 |
| 4 | $\frac{0.85 + 0.84 + 0.83 + 0.95 + 0.83}{5} = 0.86$ | 2 |

The second sub-step of step S507 is to calculate a second average score GₖRᵢ for each speech recognition service according to the scores corresponding to the previous users in the user group which the current user (e.g., user F) is categorized into, wherein k represents the index of the user group which the current user is categorized into). Assuming that the current user (e.g., user F) is categorized into the user group of “Taipei” in step S503, the second average scores of all speech recognition services, and the sorting order of the second average scores may be determined as follows in Table 3.

TABLE 3

| Index (i) of speech | | Sorting order of GₖRᵢ |
|---|---|---|
| recognition service | GₖRᵢ | (second sorting order) |
| 1 | $\frac{0.9 + 0.88}{2} = 0.89$ | 1 |
| 2 | $\frac{0.85 + 0.8}{2} = 0.825$ | 4 |
| 3 | $\frac{0.84 + 0.86}{2} = 0.85$ | 2 |
| 4 | $\frac{0.85 + 0.84}{2} = 0.845$ | 3 |

The third sub-step of step S507 is to generate an integrative score FRᵢ for each speech recognition service according to weighted averages of the first average scores (ARᵢ) and the second average scores (GₖRᵢ) with a weighting ratio α. According to the data in Tables 2˜3, the integrative scores of all speech recognition services and the sorting order of the integrative scores may be determined (with α=0.6) as follows in Table 4.

TABLE 4

| | | Sorting order of |
|---|---|---|
| Index (i) of speech | | FRᵢ (third |
| recognition service | FRᵢ | sorting order) |
| 1 | 0.6 × 0.89 + (1 − 0.6) × | 1 |
| | 0.858 = 0.8772 | |
| 2 | 0.6 × 0.825 + (1 − 0.6) × | 4 |
| | 0.834 = 0.8286 | |
| 3 | 0.6 × 0.85 + (1 − 0.6) × | 2 |
| | 0.886 = 0.8644 | |
| 4 | 0.6 × 0.845 + (1 − 0.6) × | 3 |
| | 0.86 = 0.851 | |

In one embodiment, the weighting ratio α may be the average of the recommendation accuracy coefficients β. Taking the database shown in Table 1 as an example, the weighting ratio α is determined as follows:

$$\frac{1 + 1 + 0 + 0 + 1}{5} = 0.6 .$$

Specifically, the generation of the recommendation list in step S508 may refer to sorting the recognition results by the third sorting order, and the recommendation list may include the sorted recognition results. Taking the third sorting order shown in Table 4 as an example, the first item in the recommendation list may be the recognition result provided by the first speech recognition service, the second item in the recommendation list may be the recognition result provided by the third speech recognition service, the third item in the recommendation list may be the recognition result provided by the fourth speech recognition service, and the fourth item in the recommendation list may be the recognition result provided by the second speech recognition service.

Fifthly, the selection feedback module 450 is responsible for sending the recommendation list to the user device 110 (step S509) for recognize the current user's speech data corresponding each of the speech recognition services, and receiving a selection feedback from the user device 110 (step S510).

Specifically, if the recommendation list includes a recognition result that the current user wants, the selection feedback may include the recognition result selected by the current user. Otherwise, if none of the recognition results in the recommendation list is what the current user wants, the current user (e.g., user F) may modify one of the recognition results and the selection feedback may include the modified recognition result.

Sixthly, the similarity determination module 460 is responsible for generating the scores corresponding to the current user (e.g., user F) for all speech recognition services according to the selection feedback, and determining a fourth sorting order according to the scores corresponding to the current user (step S511). Also, the similarity determination module 460 is responsible for determining the recommendation accuracy coefficient for the current recommendation according to the fourth sorting order (step S512), and storing the scores corresponding to the current user (e.g., user F) for all speech recognition services in the database (step S513).

Specifically, the similarity determination module 460 may calculate the similarities between each of the recognition results provided by the speech recognition services and the user's selection feedback, and the similarities may be used to represent the scores of all speech recognition services for the current user (e.g., user F).

For clarification purposes, it is assumed that all the recognition results in the recommendation list are not what the current user wants, and the selection feedback includes the modified recognition result: “ [symbol] ”. Accordingly, the similarities between each of the recognition results and the selection feedback may be calculated as follows in Table 5.

TABLE 5

| Index (i) | | | |
|---|---|---|---|
| of speech | | | Sorting order of |
| recognition | | Similarity | similarities (fourth |
| service | recognition result | (i.e., Rᵢ) | sorting order) |
| 1 | [symbol] | $\frac{6}{7} = 0.857$ | 1 |
| 2 | [symbol] | $\frac{5}{7} = 0.714$ | 2 |
| 3 | [symbol] | $\frac{5}{7} = 0.714$ | 2 |
| 4 | [symbol] | $\frac{5}{7} = 0.714$ | 2 |

As shown in Table 5, the difference between each recognition result and the selection feedback is underlined, and the similarity between a recognition result and the selection feedback is determined by dividing the number of correct words with the number of all words.

As shown in Tables 3 and 5, the first item in the fourth sorting order is the same as the first item in the second sorting order, and thus, the recommendation accuracy coefficient for this recommendation is set to 1. Otherwise, if the first item in the fourth sorting order is different from the first item in the second sorting order, the recommendation accuracy coefficient for this recommendation is set to 0.

Subsequent to step S513, one more entry representing the scores corresponding to the current user (e.g., user F) and the recommendation accuracy coefficient for the current recommendation is added to the database, as shown in Table 6.

TABLE 6

| User | Grouping | R1 | R2 | R3 | R4 | β |
|---|---|---|---|---|---|---|
| User A | Taipei | 0.9 | 0.85 | 0.84 | 0.85 | 1 |
| User B | Taipei | 0.88 | 0.8 | 0.86 | 0.84 | 1 |
| User C | Taichung | 0.82 | 0.82 | 0.92 | 0.83 | 0 |
| User D | Kaosiung | 0.83 | 0.85 | 0.88 | 0.95 | 0 |
| User E | Shanghai | 0.86 | 0.85 | 0.93 | 0.83 | 1 |
| User F | Taipei | 0.857 | 0.714 | 0.714 | 0.714 | 1 |

Using the recommendation accuracy coefficients shown in Table 6 as an example, the weighting ratio for the next recommendation may be determined as follows:

$$\frac{1 + 1 + 0 + 0 + 1 + 1}{6} = 0.7$$

(round off to the nearest tenth). That is, the weighting ratio may be updated as the number of entries in the database increases.

In view of the foregoing embodiments, it will be appreciated that the integrated speech recognition systems and methods are characterized in that the scores of different speech recognition services are analyzed according to the result of user grouping, so as to recommend the speech recognition service with better accuracy for the current user. Please note that, although the user grouping in the example of Tables 1˜6 is performed based on the users' locations, the present application should not be limited thereto. For example, other user data (e.g., gender information, and age information) and/or device data (e.g., device model, and OS version) may be used as the basis for user grouping.

While the application has been described by way of example and in terms of preferred embodiment, it should be understood that the application cannot be limited thereto. Those who are skilled in this technology can still make various alterations and modifications without departing from the scope and spirit of this application. Therefore, the scope of the present application shall be defined and protected by the following claims and their equivalents.

Note that use of ordinal terms such as “first”, “second”, etc., in the claims to modify a claim element does not by itself connote any priority, precedence, or order of one claim element over another or the temporal order in which acts of the method are performed, but are used merely as labels to distinguish one claim element having a certain name from another element having the same name (except for use of ordinal terms), to distinguish the claim elements.

What is claimed is:

1. An integrated speech recognition system, comprising:
a storage device, configured to store a plurality of first scores corresponding to a plurality of users for each of a plurality of speech recognition services;
a controller, configured to select a first user group from a plurality of user groups according to user data, obtain a plurality of recognition results which are generated by the speech recognition services for the same speech data, and generate a recommendation list by sorting the recognition results according to the first scores corresponding to the users in the first user group.

2. The integrated speech recognition system of claim 1, wherein the generation of the recommendation list further comprises:
generating a first average score for each of the speech recognition services according to the first scores corresponding to the users;
determining a first sorting order according to the first average scores;
generating a second average score for each of the speech recognition services according to the first scores corresponding to the users in the first user group;
determining a second sorting order according to the second average scores;
generating an integrative score for each of the speech recognition services according to weighted averages of the first average scores and the second average scores with a weighting ratio; and
determining a third sorting order according to the integrative scores.

3. The integrated speech recognition system of claim 1, wherein the controller is further configured to generate a plurality of second scores of the speech recognition services for a new user according to similarities between each of the recognition results and a selection feedback of the new user, determine a fourth sorting order according to the second scores, and determine a recommendation accuracy coefficient according to a comparison between first items of the fourth sorting order and the second sorting order.

4. The integrated speech recognition system of claim 2, wherein the storage device is further configured to store a plurality of recommendation accuracy coefficients corresponding to the users, and the controller is further configured to determine the weighting ratio according to the recommendation accuracy coefficients.

5. The integrated speech recognition system of claim 1, wherein the user data comprises at least one of the following:
an Internet Protocol (IP) address;
location information;
gender information; and
age information.

6. An integrated speech recognition method, executed by a server comprising a storage device storing a plurality of first scores corresponding to a plurality of users for each of a plurality of speech recognition services, the integrated speech recognition method comprising:
selecting a first user group from a plurality of user groups according to user data;
obtaining a plurality of recognition results which are generated by the speech recognition services for the same speech data; and
generating a recommendation list by sorting the recognition results according to the first scores corresponding to the users in the first user group.

7. The integrated speech recognition method of claim 6, wherein the generation of the recommendation list further comprises:
generating a first average score for each of the speech recognition services according to the first scores corresponding to the users;
determining a first sorting order according to the first average scores;
generating a second average score for each of the speech recognition services according to the first scores corresponding to the users in the first user group;
determining a second sorting order according to the second average scores;
generating an integrative score for each of the speech recognition services according to weighted averages of the first average scores and the second average scores with a weighting ratio; and
determining a third sorting order according to the integrative scores.

8. The integrated speech recognition method of claim 6, further comprising:
generating a plurality of second scores of the speech recognition services for a new user according to similarities between each of the recognition results and a selection feedback of the new user;
determining a fourth sorting order according to the second scores, and determine the recommendation accuracy coefficient according to a comparison between first items of the fourth sorting order and the second sorting order.

9. The integrated speech recognition method of claim 7, wherein the storage device is further configured to store a plurality of recommendation accuracy coefficients corresponding to the users, and the integrated speech recognition method further comprises:
determining the weighting ratio according to the recommendation accuracy coefficients.

10. The integrated speech recognition method of claim 6, wherein the user data comprises at least one of the following:
an Internet Protocol (IP) address;
location information;
gender information; and
age information.
